(19) United States
(12) Patent Application Publication
(10) Pub. No.: US 2026/0295482 A1
(43) Pub. Date: Oct. 1, 2026

(54) DEVICES, SYSTEMS, AND METHODS, FOR INTEGRATING OF A FLUID SERVICE ASSEMBLY INTO A MACHINE

(71) Applicant: RPM INDUSTRIES, LLC, Washington, PA (US)

(72) Inventor: John K. Apostolides, Wexford, PA (US)

(21) Appl. No.: 19/152,396

(22) PCT Filed: Mar. 14, 2025
(86) PCT No.: PCT/US2025/019911

§ 371 Date: Jul. 30, 2025

(51) Int. Cl. B01D 35/157; B01D 36/00; B01D 37/04

(52) U.S. Cl. CPC B01D 35/1573; B01D 36/003; B01D 37/04

(57) ABSTRACT

A fluid filter of a machine is disclosed herein. The fluid filter can include a housing and a fluid service assembly integrated within the housing. The fluid service assembly can include a first port configured for fluidic communication with a fluid component configured to generate a fluidic pressure, a second port fluidically coupled to a reservoir of the machine, and a valve assembly configured to transition between a first position and a second position in response to the fluidic pressure generated by the fluid component. In the first position, a first fluid path between the first port and a filter of the machine is open and a second fluid path between the reservoir and the second port is closed. In the second position, the first fluid path between the first port and the filter is closed and the second fluid path between the reservoir and the second port is open.

### FIELD

The present disclosure is generally related to fluid systems of machines and, more particularly, is directed to valve assemblies integrated within or otherwise integral to various components of a machine to enhance the performance of fluid services on the machine.

### SUMMARY

In some aspects, the present disclosure is directed to a system. The system can include a machine with a filter and a reservoir, and a fluid service assembly integral to the filter of the machine. The fluid service assembly can include a first port configured for fluidic communication with a fluid component configured to generate a fluidic pressure, a second port fluidically coupled to the reservoir of the machine, and a valve assembly configured to transition between a first position and a second position in response to the fluidic pressure generated by the fluid component. In the first position, a first fluid path between the first port and the filter of the machine is open and a second fluid path between the reservoir and the second port is closed. In the second position, the first fluid path between the first port and the filter of the machine is closed and the second fluid path between the reservoir and the second port is open.

In other non-limiting aspects, the present disclosure is directed to a fluid filter of a machine. The fluid filter can include a housing and a fluid service assembly integrated within the housing. The fluid service assembly can include a first port configured for fluidic communication with a fluid component configured to generate a fluidic pressure, a second port fluidically coupled to a reservoir of the machine, and a valve assembly configured to transition between a first position and a second position in response to the fluidic pressure generated by the fluid component. In the first position, a first fluid path between the first port and the filter of the machine is open and a second fluid path between the reservoir and the second port is closed. In the second position, the first fluid path between the first port and a filter positioned within the housing is closed and the second fluid path between the reservoir and the second port is open.

In still other non-limiting aspects, the present disclosure is directed to a method of integrating a fluid service assembly into a machine. The method can include providing a filter housing of the machine, defining a first port in the filter housing of the machine, defining a first fluid path between the first port and a filter positioned within the filter housing, defining a second port in the filter housing of the machine, defining a second fluid path between the second port and a reservoir of the machine, installing a valve assembly within the filter housing, wherein, in a second position, the valve assembly closes the first fluid path and opens the second fluid path, and, wherein, in a first position, the valve assembly opens the first fluid path and closes the second fluid path.

In still other non-limiting aspects, the present disclosure is directed to a method of performing a fluid service on a machine via an integral a fluid service assembly of the machine. The method can include receiving a positive fluid pressure via a first port of a fluid service assembly integral to a machine, opening, via a valve assembly of the fluid service assembly, a fluid path between the first port and a filter of the machine in response to the positive fluid pressure generated by a fluid component fluidically coupled to the first port, performing a positive pressure fluid service on the machine via the positive fluid pressure, receiving a negative fluid pressure via a second port of the fluid service assembly integral to the machine, opening a fluid path between the second port and a reservoir of the machine in response to the negative fluid pressure generated by the first fluid component fluidically coupled to the first port, and performing a negative pressure fluid service on the machine via the negative fluid pressure.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a block diagram of a system featuring a fluid service assembly integrated into a machine, in accordance with at least one non-limiting aspect of the present disclosure;

FIG. 2 illustrates a perspective view of the fluid service assembly of the system of FIG. 1, in accordance with at least one non-limiting aspect of the present disclosure;

FIGS. 3A and 3B illustrate a front and side view of the fluid service assembly of FIG. 2, respectively, in accordance with at least one non-limiting aspect of the present disclosure;

FIG. 4 illustrates a flow diagram of a method of performing a fluid service on a machine via an integral a fluid service assembly of the machine, in accordance with at least one non-limiting aspect of the present disclosure; and

FIG. 5 illustrates a flow diagram of a method of integrating a fluid service assembly into a machine, in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

Before explaining various aspects of the devices, systems, and methods for establishing a fluidic connection with a gender agnostic actuator, it should be noted that the illustrative examples are not limited in application or use to the details disclosed in the accompanying drawings and description. It shall be appreciated that the illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof.

The term “machine” as applied herein may include any equipment suitable for use in accordance with the present techniques, methods, and systems. Examples of “machines” as applied herein can include, without limitation, lubrication systems, engines, diesel engines, large-scale diesel engines, motors, rotating equipment, hydraulic equipment, pneumatic equipment, generators, aircraft engines, emergency machines, emergency generators, compressors, equipment that includes a machine (e.g., such as mining equipment, construction equipment, marine equipment, aircraft, etc.), and many other machines. As described in various portions of the present disclosure, the example of an “engine” is employed for convenience of disclosure in describing various embodiments and aspects of the present invention. It can be appreciated by those skilled in the art, however, that such use of “engine” as one example of a type of machine is intended merely for convenience of disclosure and is not necessarily intended to limit the scope of the invention.

Another example of a machine is a “fluid reservoir system” which may include any reasonable combination of fluid reservoirs, fluid components such as valves, pumps, and/or other components suitable for incorporation into a fluid reservoir system.

The term “evacuation” as applied to the systems and methods disclosed herein may include evacuation of any portion of a fluid of a machine, a receptacle, a reservoir, or other like fluid-retaining system or apparatus. Similarly, the term “refill” as applied to the systems and methods disclosed herein may include refill of any portion of the fluid capacity of a machine, receptacle, reservoir, or other like fluid-retaining system or apparatus.

The term “valve assembly” as applied to the systems and methods disclosed herein may include any combination of valves, pipes, disconnects, adapters and other like structural components configured for performing one or more fluid purge, evacuation, and/or refill processes.

Examples of valves included within a valve system may include, without limitation, single-position valves, multi-position valves (e.g., such as junction block assemblies or five-way control valves), mechanical valves, electronic valves, electro-mechanical valves, and/or other types of valves with or without electronic control for actuating the various possible open or closed positions of such valves.

Where suitable and applicable to the various embodiments of the present systems and methods discussed herein, it can be appreciated that various components, structures, elements, and other configurations may be applied or installed in a location considered external or internal to the operation of a particular machine. In applicable portions herein in which the use of pumps and/or supplemental pumps is disclosed, for example, such pumps may be positioned, installed, or operated as internal components of a machine and/or as externally positioned components that assist, or otherwise operate in conjunction with, the functions of the machine. For example, in certain embodiments a supplemental pump or other engine component may be considered “onboard” with respect to the machine.

As employed herein, the term “type” or “kind” used with regard to various fluids discussed herein is intended to distinguish different types or kinds of fluids between/among each other. For example, oil is considered one “type” of fluid, transmission fluid is considered another, different “type” of fluid, and hydraulic fluid is considered another, different “type” of fluid. It should be noted, for example, that a used amount of a “type” of fluid is not considered different with respect to a clean or fresh fluid of the same “type” (e.g., clean oil used in a fluid refill or replacement process for a machine is not considered a different “type” of fluid with respect to the used oil drained from the machine during a fluid evacuation process).

It is critically important to perform periodic fluid operations, such as evacuations, line purges, and refills, on industrial machines. However, convention devices, systems, and methods for performing fluid operations on industrial machines present several problems. For example, conventional devices, systems, and methods may utilize supplemental valve assemblies configured to be coupled to industrial machines via multiple, external lines that result in backflow, which can lead to contamination or reintroduction of old fluids or debris into the machine. Additionally, multiple, external lines may make it more difficult to maintain pressure stability during a fluid operation and can result in air pockets, cavitation, or fluid loss that could impact the performance of the machine. Furthermore, having multiple, external lines can complicate the fluid handling process and result in safety hazards, which can lead to trips, and injuries amongst operating technicians. Such lines can also slow down an operation, requiring more time for caution as well as complicated setup procedures, including multiple connections. Having multiple connections can also increase the risk of spills or leaks, creating multiple failure points in the system.

Accordingly, there is a need for device, systems, and methods for integrating a fluid service assembly into a machine. Such devices, systems, and methods could enhance the reliability and cleanliness of fluid operations performed on the machine, simplify maintenance, reduce the time necessary for set up and tear down between fluid operations, and improve the overall performance and lifespan of the machine. Specifically, such devices, systems, and methods can be implemented via a filter of the machine, which can be configured to remove particles from a fluid (e.g., oil, hydraulic fluid, coolants, etc.) that circulates into and out of the machine. Thus, such devices, systems, and methods can maintain filter integrity by ensuring optimal pressure and vacuums are provided to the filter, eliminating the need for a “dry start” of the machine, and eliminating intermediate lines and/or devices when filling the filter with new fluids.

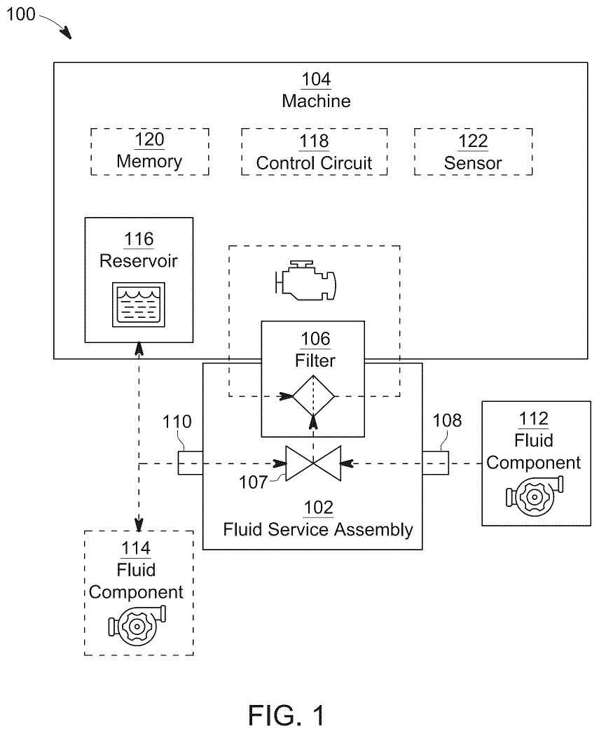

Referring now to FIG. 1, a block diagram of a system 100 featuring a fluid service assembly 102 integrated into a machine 104 is depicted according to at least one non-limiting aspect of the present disclosure. According to the non-limiting aspect of FIG. 1, the system can include a fluid service assembly 102 that is directly and fluidically coupled to a machine 104. The machine 104, for example, can include an internal combustion engine. However, according to other non-limiting aspects, the machine 104 can include a lubrication system, other types of engines, diesel engines, motors, rotating equipment, hydraulic equipment, pneumatic equipment, generators, aircraft engines, emergency machines, emergency generators, compressors, and/or equipment that includes a machine (e.g., such as mining equipment, construction equipment, marine equipment, aircraft, etc.), amongst others. The fluid service assembly 102 can be either integral or directly fluidically coupled to a filter 106 of the machine 104. In other words, the fluid service assembly 102 can be in direct, mechanical engagement with the filter 106 and no ancillary hose, line, or other conduit is required to establish fluidic communication between the two.

In further reference to FIG. 1, the fluid service assembly 102 can include a valve assembly 107, a first port 108, and a second port 110. For example, the first port 109 of the fluid service assembly 102 can be configured to establish mechanical and fluidic communication between fluid service assembly 102 and a fluid component 112. The fluid component 112, for example, can be configured to supply a positive and/or negative fluid pressure to the first port 108. For example, the fluid component 112 can be employed in connection with the valve assembly 107 to perform a fluid service on the filter 106 and/or the reservoir 116 of the machine 104, including a purge process on the filter 106, a fluid evacuation process on the reservoir 116, and/or a fluid refill process of the filter 106 and/or other components of the machine 104, amongst others. The first port 108 can also include a mechanism that facilitates ease of mechanical connection and fluidic communication with the fluid component 112, such as a quick fit connector, a barbed fitting, a crimp, a push-button connector, a threaded connection, and/or a pull collar connector, amongst others. The fluid component 112 can include, for example, a pump and/or a flow control (e.g., a hand-held device, including a bracket or an evacuation bracket), amongst others.

Still referring to FIG. 1, the second port 110 can be configured to establish mechanical and fluidic communication between the fluid service assembly 102 and the reservoir 116 of the machine 104. For example, the reservoir 116 can be configured to contain fluid used by the machine 104, such as a sump, a fuel tank, a transmission fluid reservoir, a waste-receiving receptacle, and/or a hydraulic fluid reservoirs, amongst other reservoirs associated with machine operation and maintenance. According to some non-limiting aspects, the second port 110 can be configured for mechanical and fluidic communication with a second fluid component 114 configured to supply a positive and/or negative fluidic pressure to the second port 110. The second fluid component 114, for example, can include a pump (e.g., a supplemental pump, a fluid reservoir pump, a pre-lubrication lump, etc.) fluidically coupled to the reservoir 116 and configured to deliver fluid from the reservoir 116 to one or more components of the machine. In other words, the second fluid component 114 can apply a vacuum to remove fluid offboard the machine 104. However, according to some non-limiting aspects, the second fluid component 114 can be an integral component of the machine 104 (e.g., a main engine pump, etc.).

The fluid service assembly 102 of the system 100 of FIG. 1 can further include a valve assembly 107 configured to selectively open and close the first port 108 and the second port 110 in response to pressures provided to the valve assembly 107 via the first port 108 and/or second port 110. As will be described in further detail herein, in response to a positive pressure provided via the first fluid component 112, the valve assembly 107 can open a fluid path from the first port 108 to the filter 106 of the machine 104 and close a fluid path from the filter 106 of the machine 104 to the second port 110. Accordingly, the valve assembly 107 can enable a positive pressure fluid service on the filter 106 and/or machine 104 via a positive fluidic pressure provided via the first fluid component 112. For example, the positive pressure fluid service can include a purge process that uses air or any other purging agent provided by the first fluid component 112 to clean the lines or filter media. Alternately, the positive pressure fluid service can include a refill process, which introduces new or refurbished fluid to the filter 106 and/or machine 104, as provided by the first fluid component 112.

Similarly, in response to a negative pressure provided via the first fluid component 112, the valve assembly 107 of the fluid service assembly 102 of the system 100 of FIG. 1 can close the fluid path from the first port 108 to the filter 106 of the machine 104 and open the fluid path from the filter 106 of the machine 104 to the second port 110. Accordingly, the valve assembly 107 can enable a negative pressure fluid service on the filter 106 and/or machine 104 via a negative fluidic pressure provided via the first fluid component 112. For example, the negative pressure fluid service can include an evacuation process that sucks fluid from the reservoir 116, a dirty side of the filter 106, and/or other components of the machine 104.

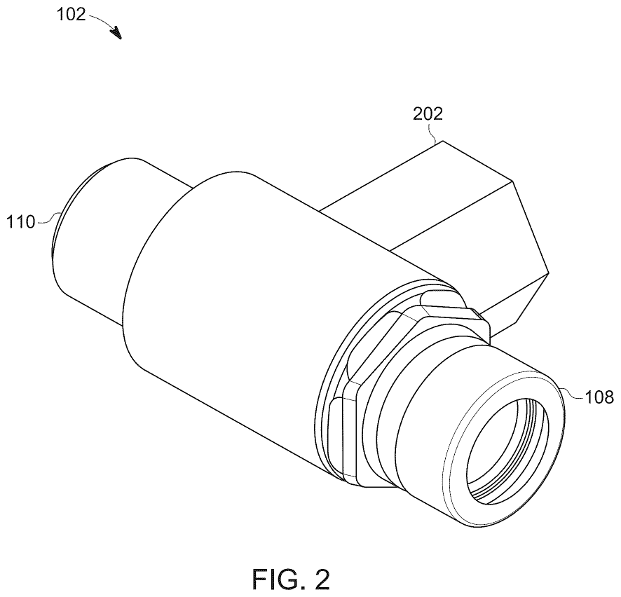

According to some non-limiting aspects, the valve assembly 107 can be biased (e.g., mechanically via spring, fluidically via the operating pressure of the machine 104, etc.) such that the fluid path from the first port 108 to the filter 106 of the machine 104 and the fluid path from the reservoir 116 of the machine 104 to the second port 110 remain closed when pressure is not being provide via the first fluid component 112. It shall be further appreciated that, according to some non-limiting aspects, the valve assembly 107 can include two or more check valves. For example, the valve assembly 107 can include a first check valve positioned adjacent the filter 106 or third port 202 (FIG. 2) and a second check valve positioned adjacent the reservoir or second port 110. In the first position, the first check valve can be open and the second check valve can be closed. In the second position, the first check valve can be closed and the second check valve can be open.

According to some non-limiting aspects, the system 100 of FIG. 1 can further include a control circuit 118 communicatively coupled to the fluid service assembly 102, the first fluid component 112, and/or a memory 120 communicatively coupled to the control circuit and configured to store instructions that, when executed by the control circuit 118, cause the control circuit 118 to perform the methods or functionality disclosed herein. The control circuit 118 can be further communicatively coupled to one or more sensors 122 configured to generate signals associated with conditions of the fluid and/or components within the machine 104. According to some aspects, the control circuit 118 can be configured to perform the methods or functionality disclosed herein based on signals received from the one or more sensors 122. For example, if the one or more sensors 122 generate signals that indicate that the filter 106 or other components within the machine 104 are contaminated beyond a predetermined threshold, the control circuit 118 can cause the the fluid service assembly 102 and/or fluid component 112 to initiate a positive pressure fluid service and/or a negative pressure fluid service, as described herein. According to one non-limiting aspect, the control circuit 118 and/or memory 120 can be positioned on or about the filter 106 and/or machine 104. However, according to other non-limiting aspects, the control circuit 118 and/or memory 120 can be remotely located relative to the machine 104.

It shall be appreciated that the fluid service assembly 102 of the system 100 of FIG. 1 can be an integral component of the machine 104, including the first port 108, the second port 110, and the valve assembly 107. For example, a housing of the filter 106 can be configured to accommodate the fluid service assembly 102 and apertures can be defined in the housing such that the first port 108 and second port 110 can be positioned and routed as described herein. According to some non-limiting aspects, the housing of the filter 106 can include, accommodate, or define a movable (e.g., flexible, swivel, etc.) joint mechanically and fluidically coupled to the first port 108 and/or second port 110, such that the first port 108 and/or the second port 110 of the fluid service assembly 102 can move or rotate relative to the fluid service assembly 102, the filter 106, the machine 104, and/or the first fluid component 112. According to some non-limiting aspects, the fluid service assembly 102 and the housing of the filter 106 can be cut, formed, molded, or produced via additive manufacturing from the same stock of material. According to other non-limiting aspects, the fluid service assembly 102 can be separately formed but permanently attached to the housing of the filter 106, such as via welding, thermal compression, or other permanent means of attachment. According to still other non-limiting aspects, the fluid service assembly 102 can be removably attached to the housing of the filter 106 (e.g., via a threaded and/or movable joint) but can establish a direct fluidic communication between the fluid service assembly 102 and the filter 106 or machine 104, without requiring any intermediate conduits or fluidic circuitry between the fluid service assembly 102 and machine 104.

Accordingly, system 100—and more specifically, the fluid service assembly 102—can enhance the reliability and cleanliness of fluid operations performed on the machine 104, simplify maintenance, reduce the time necessary for set up and tear down between fluid operations, and can improve the overall performance and lifespan of the machine 104. Additionally, without the need for ancillary, external lines, conduits, or valves, the fluid service assembly 102 can maintain filter 106 integrity by ensuring optimal pressure and vacuums are provided to the filter 106, eliminating the need for a “dry start” of the machine 104, and streamlining refill procedures performed on the machine 104 and/or filter 106. The system 100 can further provide safety and/or environmental benefits compared to conventional devices, systems, and methods.

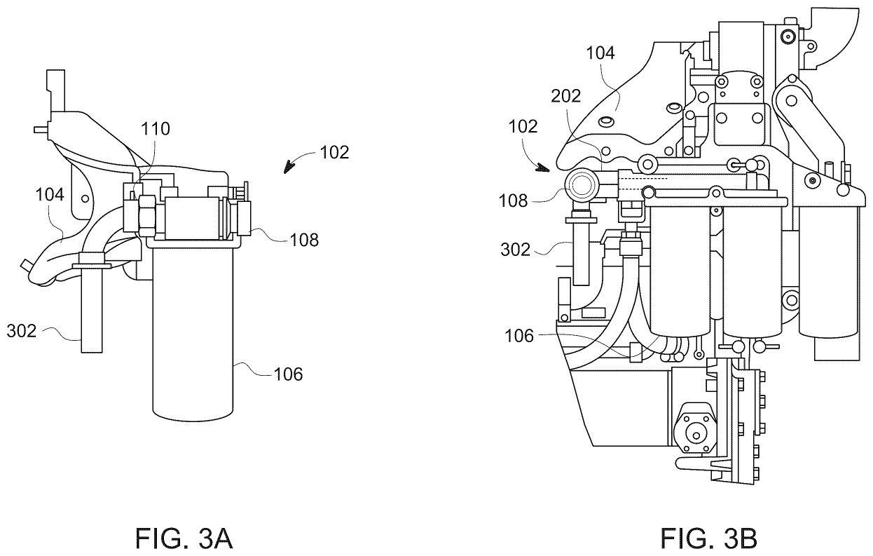

Referring now to FIG. 2, a perspective view of the integral fluid service assembly 102 of the system of FIG. 1 is depicted according to at least one non-limiting aspect of the present disclosure. Specifically, the first port 108, the second port 110, and a third port 202 of the fluid service assembly 102 are depicted in further detail. The third port 202 can be configured to connect fluidically couple the fluid service assembly 102 to one or more fluid conduits of the machine 104 (FIG. 1) and can further include a movable (e.g., flexible, swivel, etc.) joint. The valve assembly 107 (FIG. 1) can be positioned within a housing of the fluid service assembly 102 and configured to selectively open and close fluid paths associated with the first port 108 and the second port 110 in response to fluidic pressures provided via those ports. As will be described in further detail with reference to FIGS. 3A and 3B, the fluid service assembly 102 can be contained within or integral to the housing of the filter 106 (FIG. 1) of the machine 104 (FIG. 1), thereby enhancing reliability, cleanliness, and efficiency of fluid operations performed on the machine 104, and improving the maintenance and usable life of the filter 106 (FIG. 1) and/or machine 104 (FIG. 1).

Referring now to FIGS. 3A and 3B, a front and side view of the fluid service assembly 102 of FIG. 2 are respectively depicted according to at least one non-limiting aspect of the present disclosure. Specifically, FIGS. 3A and 3B illustrate how the fluid service assembly 102 can be integrated into the filter 106 or any other component of the machine 104. As depicted in the front view of FIG. 3A, the second port 108 can be mechanically and fluidically coupled to the reservoir 116 (FIG. 1) of the machine 104 via a suction line 302. The first port 108 is positioned in a readily accessible location of the machine 104 for ease of connection and ease of access can be further facilitated by one or more of the aforementioned movable joints. According to the side view of FIG. 3B, it is shown that the filter 106 can be a first filter of a plurality of filters of the machine 104. Unlike conventional devices and systems, it is evident that the fluid service 102 assembly is an integral, natural component of the machine 104, which eliminates the need for ancillary devices, lines, and/or valve assemblies that could reduce the efficiency, cleanliness, and/or efficacy of fluid services performed on the machine 104.

In further reference to FIGS. 3A and 3B, in response to a positive pressure provided by the fluid component 112 (FIG. 1) via the first port 108, the valve assembly 107 (FIG. 1) can transition to the first position, wherein a fluid path from the first port 108 to the filter 106 of the machine 104 is open and a fluid path from the filter 106 of the machine 104 to the second port 110 is closed. The positive pressure, for example, can be fluidic pressure provided via the first fluid component 112 (FIG. 1) (e.g., a pump) or mechanical pressure provided via a connection (e.g. a quick fit connection) of the first fluid component 112 to the first port 108. Accordingly, the first fluid component 112 can perform a positive pressure fluid service on the filter 106 and/or machine 104, such as a purge process that uses air or any other purging agent to clean the lines or filter media, or a refill process, which introduces new or refurbished fluid.

However, in response to a negative pressure (e.g., a vacuum) provided by the first fluid component 112 (FIG. 1) via the first port 108, the valve assembly 107 (FIG. 1) can transition to the second position, wherein the fluid path from the reservoir 116 (FIG. 1) of the machine 104 to the second port 110 is open and the fluid path from the first port 108 to the filter 106 of the machine 104 is closed. Accordingly, the valve assembly 107 (FIG. 1) can enable a negative pressure fluid service on the filter 106 and/or machine 104 via a negative fluidic pressure provided via the first fluid component 112 (FIG. 1). For example, the negative pressure fluid service can include an evacuation process that sucks fluid from the reservoir 116 (FIG. 1), a dirty side of the filter 106, and/or other components of the machine 104.

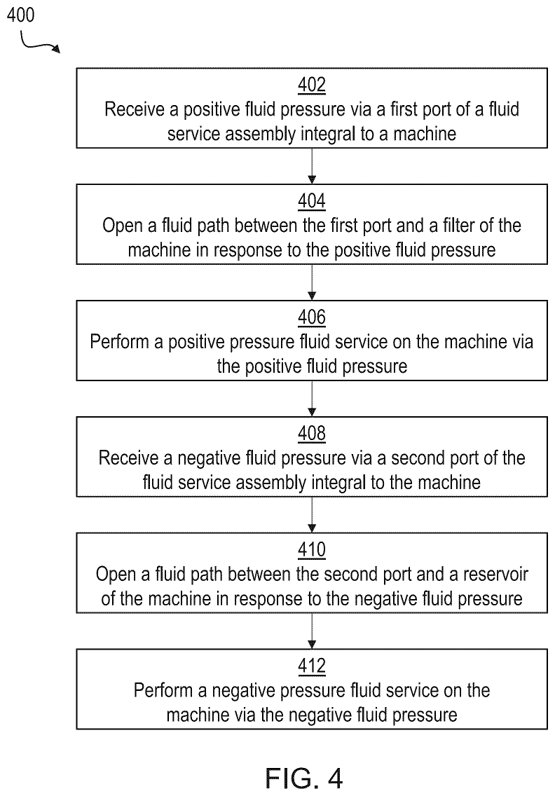

Referring now to FIG. 4, a flow diagram of a method 400 of performing a fluid service on a machine 104 (FIG. 1) via an integral a fluid service assembly 102 (FIG. 1) of the machine 104 (FIG. 1) is depicted according to at least one non-limiting aspect of the present disclosure. It shall be appreciated that, according to some non-limiting aspects, the method can be performed via a control circuit 118 (FIG. 1) upon executing instructions stored in the memory 120 (FIG. 1).

According to FIG. 4, the method 400 can include receiving 402 a positive fluid pressure via a first port 108 (FIG. 1) of a fluid service assembly 102 (FIG. 1) integral to a machine 104 (FIG. 1). The method 400 can further include opening 404, via a valve assembly 107 (FIG. 1) of the fluid service assembly 102 (FIG. 1), a fluid path between the first port 108 (FIG. 1) and a filter 106 (FIG. 1) of the machine 104 (FIG. 1) in response to the positive fluid pressure. The positive fluid pressure, for example, can be generated by a first fluid component 112 (FIG. 1). The method 400 can further include performing a positive pressure fluid service on the machine 104 (FIG. 1) via the positive fluid pressure.

Still referring to FIG. 4, the method 400 can further include receiving 408 a negative fluid pressure via a second port 110 (FIG. 1) of the fluid service assembly 102 (FIG. 1) integral to the machine 104 (FIG. 1). The method 400 can further include opening 410 a fluid path between the second port 110 (FIG. 1) and a reservoir 116 (FIG. 1) of the machine 104 (FIG. 1) in response to the negative fluid pressure. The negative fluid pressure, for example, can be generated by a first fluid component 112 (FIG. 1). The method 400 can further include performing 412 a negative pressure fluid service on the machine 104 (FIG. 1) via the negative fluid pressure. According to some non-limiting aspects, one or more of the steps of the method 400 of FIG. 4 can be performed in response to a signal received from the sensor 122 (FIG. 1).

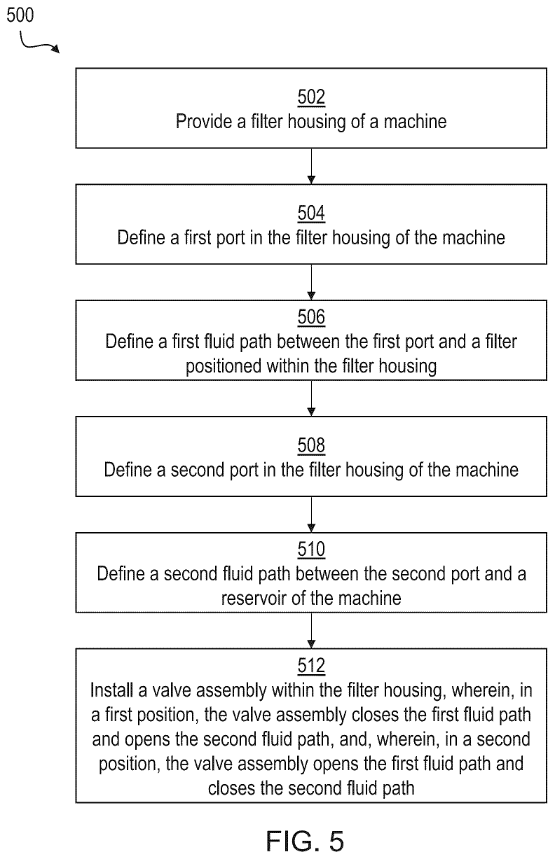

Referring now to FIG. 5, a flow diagram of a method 500 of integrating a fluid service assembly 102 (FIG. 1) into a machine 104 (FIG. 1) is depicted according to at least one non-limiting aspect of the present disclosure. The method 500 can further include providing 502 a filter 106 (FIG. 1) housing of a machine 104 (FIG. 1). The method 500 can further include defining 502 a first port 108 (FIG. 1) in the filter 106 (FIG. 1) housing of the machine 104 (FIG. 1). The method 500 can further include defining 506 a first fluid path between the first port 108 (FIG. 1) and a filter 106 (FIG. 1) positioned within the filter 106 (FIG. 1) housing. The method 500 can further include defining 508 a second port 110 (FIG. 1) in the filter 106 (FIG. 1) housing of the machine 104 (FIG. 1). The method 500 can further include defining 510 a second fluid path between the second port 110 (FIG. 1) and a reservoir 116 (FIG. 1) of the machine 104 (FIG. 1). The method 500 can further include installing a valve assembly 107 (FIG. 1) within the filter 106 (FIG. 1) housing, wherein, in a second position, the valve assembly 107 (FIG. 1) closes the first fluid path and opens the second fluid path, and, wherein, in a first position, the valve assembly 107 (FIG. 1) opens the first fluid path and closes the second fluid path.

According to one non-limiting aspect, the method 500 of FIG. 5 can be performed via cutting, forming, molding, additive manufacturing using a stock of material. According to other non-limiting aspects, the method 500 can be performed by separately forming one or more components of the fluid service assembly 102 (FIG. 1) and/or machine 104 (FIG. 1) and permanently attaching the separately formed components via a process such as welding, thermal compression, or other permanent means of attachment.

Various aspects of the subject matter described herein are set out in the following numbered clauses:

Clause 1: A system, including a machine including a filter and a reservoir, a fluid service assembly integral to the filter of the machine, wherein the fluid service assembly includes a first port configured for fluidic communication with a fluid component configured to generate a fluidic pressure, a second port fluidically coupled to the reservoir of the machine, and a valve assembly configured to transition between a first position and a second position in response to the fluidic pressure generated by the fluid component, wherein in the second position, a first fluid path between the first port and the filter of the machine is closed and a second fluid path between the reservoir and the second port is open, and wherein, in the first position, the first fluid path between the first port and the filter of the machine is open and the second fluid path between the reservoir and the second port is closed.

Clause 2. The system according to clause 1, wherein the valve assembly is configured to transition from the second position to the first position in response to a positive pressure provided by the fluid component.

Clause 3. The system according to either of clauses 1 or 2, wherein the fluid service assembly and the fluid component are collectively configured to perform a positive pressure fluid service on the machine when the valve assembly is in the first position based on the positive pressure provided by the fluid component.

Clause 4. The system according to any of clauses 1-3, wherein the positive pressure fluid service includes a purge process, a refill process, or combinations thereof.

Clause 5. The system according to any of clauses 1-4, wherein the valve assembly is configured to transition from the first position to the second position in response to a negative pressure provided by the fluid component.

Clause 6: The system according to any of clauses 1-5, wherein the fluid service assembly and the fluid component are collectively configured to perform a negative pressure fluid service on the machine when the valve assembly is in the second position based on the negative pressure provided by the fluid component.

Clause 7: The system according to any of clauses 1-6, wherein the negative pressure fluid service includes an evacuation process.

Clause 8: The system according to any of clauses 1-7, further including a control circuit communicatively coupled to the fluid service assembly and a memory communicatively coupled to the control circuit and configured to store instructions that, when executed by the control circuit, cause the control circuit to cause the valve assembly to transition between the second position and the first position.

Clause 9: The system according to any of clauses 1-8, further including a sensor communicatively coupled to the control circuit, wherein the sensor is configured to generate signals indicative of a condition of the machine.

Clause 10: The system according to any of clauses 1-9, wherein the control circuit is further configured to receive a signal from the sensor, and cause the valve assembly to transition between the second position and the first position based on the received signal.

Clause 11: The system according to any of clauses 1-10, wherein the fluid service assembly and a housing of the filter are integrally formed from a stock of material via cutting process, a forming process, a molding process, or additive manufacturing process, or combinations thereof.

Clause 12: The system according to any of clauses 1-11, wherein the fluid service assembly and a housing of the filter are separately formed and permanently attached.

Clause 13: The system according to any of clauses 1-12, wherein the permanent attachment is performed via a welding process or a thermal compression process.

Clause 14: The system according to any of clauses 1-13, wherein the a fluid service assembly further includes a movable joint configured to enable the first port or the second port to move relative to the machine.

Clause 15. A fluid filter of a machine, including a housing, and a fluid service assembly integrated within the housing, wherein the fluid service assembly includes a first port configured for fluidic communication with a fluid component configured to generate a fluidic pressure, a second port fluidically coupled to a reservoir of the machine, and a valve assembly configured to transition between a first position and a second position in response to the fluidic pressure generated by the fluid component, wherein in the second position, a first fluid path between the first port and a filter positioned within the housing is closed and a second fluid path between the reservoir and the second port is open, and wherein, in the first position, the first fluid path between the first port and the filter of the machine is open and the second fluid path between the reservoir and the second port is closed.

Clause 17: The fluid filter according to clause 16, wherein the valve assembly is configured to transition from the second position to the first position in response to a positive pressure provided by the fluid component.

Clause 18: The fluid filter according to either of clauses 16 or 17, wherein the valve assembly is configured to transition from the first position to the second position in response to a negative pressure provided by the fluid component.

Clause 19. A method of integrating a fluid service assembly into a machine, the method including providing a filter housing of the machine, defining a first port in the filter housing of the machine, defining a first fluid path between the first port and a filter positioned within the filter housing, defining a second port in the filter housing of the machine, defining a second fluid path between the second port and a reservoir of the machine, installing a valve assembly within the filter housing, wherein, in a second position, the valve assembly closes the first fluid path and opens the second fluid path, and, wherein, in a first position, the valve assembly opens the first fluid path and closes the second fluid path.

Clause 20. A method of performing a fluid service on a machine via an integral a fluid service assembly of the machine, the method including receiving a positive fluid pressure via a first port of a fluid service assembly integral to a machine, opening, via a valve assembly of the fluid service assembly, a fluid path between the first port and a filter of the machine in response to the positive fluid pressure generated by a fluid component fluidically coupled to the first port, performing a positive pressure fluid service on the machine via the positive fluid pressure, receiving a negative fluid pressure via a second port of the fluid service assembly integral to the machine, opening a fluid path between the second port and a reservoir of the machine in response to the negative fluid pressure generated by the first fluid component fluidically coupled to the first port, and performing a negative pressure fluid service on the machine via the negative fluid pressure.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements but is not limited to possessing only those one or more elements. Likewise, an element of a system, device, or apparatus that “comprises,” “has,” “includes” or “contains” one or more features possesses those one or more features but is not limited to possessing only those one or more features.

Instructions used to program logic to perform various disclosed aspects can be stored within a memory in the system, such as dynamic random-access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random-access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microcontroller configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instructions sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively, or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively, or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively, or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

The terms “proximal” and “distal” are used herein with reference to a clinician manipulating the handle portion of the surgical instrument. The term “proximal” refers to the portion closest to the clinician and the term “distal” refers to the portion located away from the clinician. It will be further appreciated that, for convenience and clarity, spatial terms such as “vertical”, “horizontal”, “up”, and “down” may be used herein with respect to the drawings. However, surgical instruments are used in many orientations and positions, and these terms are not intended to be limiting and/or absolute.

What is claimed is:

1. A system, comprising:
a machine comprising a filter and a reservoir;
a fluid service assembly integral to the filter of the machine, wherein the fluid service assembly comprises:
a first port configured for fluidic communication with a fluid component configured to generate a fluidic pressure;
a second port fluidically coupled to the reservoir of the machine; and
a valve assembly configured to transition between a first position and a second position in response to the fluidic pressure generated by the fluid component, wherein, in the first position, a first fluid path between the first port and the filter of the machine is open and a second fluid path between the reservoir and the second port is closed, and wherein in the second position, the first fluid path between the first port and the filter of the machine is closed and the second fluid path between the reservoir and the second port is open.

2. The system of claim 1, wherein the valve assembly is configured to transition to the first position in response to a positive pressure provided by the fluid component.

3. The system of claim 2, wherein the fluid service assembly and the fluid component are collectively configured to perform a positive pressure fluid service on the machine when the valve assembly is in the first position based on the positive pressure provided by the fluid component.

4. The system of claim 3, wherein the positive pressure fluid service comprises a purge process, a refill process, or combinations thereof.

5. The system of claim 1, wherein the valve assembly is configured to transition to the second position in response to a negative pressure provided by the fluid component.

6. The system of claim 5, wherein the fluid service assembly and the fluid component are collectively configured to perform a negative pressure fluid service on the machine when the valve assembly is in the second position based on the negative pressure provided by the fluid component.

7. The system of claim 6, wherein the negative pressure fluid service comprises an evacuation process.

8. The system of claim 1, further comprising a control circuit communicatively coupled to the fluid service assembly and a memory communicatively coupled to the control circuit and configured to store instructions that, when executed by the control circuit, cause the control circuit to cause the valve assembly to transition between the second position and the first position.

9. The system of claim 8, further comprising a sensor communicatively coupled to the control circuit, wherein the sensor is configured to generate signals indicative of a condition of the machine.

10. The system of claim 9, wherein the control circuit is further configured to:
receive a signal from the sensor; and
cause the valve assembly to transition between the second position and the first position based on the received signal.

11. The system of claim 1, wherein the fluid service assembly and a housing of the filter are integrally formed from a stock of material via cutting process, a forming process, a molding process, or additive manufacturing process, or combinations thereof.

12. The system of claim 1, wherein the fluid service assembly and a housing of the filter are separately formed and permanently attached.

13. The system of claim 12, wherein the permanent attachment is performed via a welding process or a thermal compression process.

14. The system of claim 1, wherein the a fluid service assembly further comprises a movable joint configured to enable the first port or the second port to move relative to the machine.

15. A fluid filter of a machine, comprising:
a housing; and
a fluid service assembly integrated within the housing, wherein the fluid service assembly comprises:
a first port configured for fluidic communication with a fluid component configured to generate a fluidic pressure;
a second port fluidically coupled to a reservoir of the machine; and
a valve assembly configured to transition between a first position and a second position in response to the fluidic pressure generated by the fluid component, wherein, in the first position, a first fluid path between the first port and a filter positioned within the housing is open and a second fluid path between the reservoir and the second port is closed, and wherein in the second position, the first fluid path between the first port and the filter positioned within the housing is closed and the second fluid path between the reservoir and the second port is open.

17. The fluid filter of claim 16, wherein the valve assembly is configured to transition to the first position in response to a positive pressure provided by the fluid component.

18. The fluid filter of claim 16, wherein the valve assembly is configured to transition to the second position in response to a negative pressure provided by the fluid component.

19. A method of integrating a fluid service assembly into a machine, the method comprising:
providing a filter housing of the machine;
defining a first port in the filter housing of the machine;
defining a first fluid path between the first port and a filter positioned within the filter housing;
defining a second port in the filter housing of the machine;
defining a second fluid path between the second port and a reservoir of the machine;
installing a valve assembly within the filter housing, wherein, in a first position, the valve assembly opens the first fluid path and closes the second fluid path, and, wherein, in a second position, the valve assembly closes the first fluid path and opens the second fluid path.

20. A method of performing a fluid service on a machine via an integral a fluid service assembly of the machine, the method comprising:
receiving a positive fluid pressure via a first port of a fluid service assembly integral to a machine;
opening, via a valve assembly of the fluid service assembly, a fluid path between the first port and a filter of the machine in response to the positive fluid pressure generated by a fluid component fluidically coupled to the first port;
performing a positive pressure fluid service on the machine via the positive fluid pressure;
receiving a negative fluid pressure via a second port of the fluid service assembly integral to the machine;
opening a fluid path between the second port and a reservoir of the machine in response to the negative fluid pressure generated by the first fluid component fluidically coupled to the first port; and
performing a negative pressure fluid service on the machine via the negative fluid pressure.
